(19) United States
(12) Patent Application Publication
(10) Pub. No.: US 2006/0081073 A1
(43) Pub. Date: Apr. 20, 2006

(54) Multi-zonal detection of explosives, narcotics, and other chemical substances

(76) Inventors: Georges Vandrish, Almyer (CA); Dao Hinh Nguyen, Ottawa (CA); Stewart Berry, Metcalfe (CA); Christopher Klymowsky, Ottawa (CA); Mathieu Parent, Clarence Creek (CA); Shirley Locquaio, Ottawa (CA)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/248,936

(22) Filed: Oct. 12, 2005

Related U.S. Application Data
(60) Provisional application No. 60/618,048, filed on Oct. 12, 2004.

(51) Int. Cl. G01N 1/24; G01N 30/62

(52) U.S. Cl. 73/864.33; 73/864.81; 73/863.81; 73/28.01; 73/23.35; 422/89

(57) ABSTRACT

A multi-zonal system and method for detecting contraband substances associated with a human subject. Objects containing such substances may be carried by the subject or in a garment worn by the subject, or as vapors entrained by the subject's garments. Alternatively, the substance may be present as small particles or residues present on skin, garment fibers, or the like that may be dislodged from the subject or his immediate effects. The system comprises: (i) an examination station through which the subject passes; (ii) sample generation means to produce a sample for analysis, comprising a plurality of air jets disposed in the examination station to impinge flowing gas onto pre-selected zones on the subject; (iii) collection means operative to acquire and convey the sample, comprising a plurality of collection ports disposed in the examination station to receive gas deflected by the subject from the air jets; (iv) analysis means in communication with the collection means to receive the sample and carry out a chemical analysis to detect the contraband substances; and (v) signal means operably connected to the analysis means for indicating detection of the contraband substances. Preferably the system employs a chemiluminescent detector based on the reaction of luminol with NO₂ produced by pyrolysis of explosive or other contraband substance and is capable of high throughput, accurate screening in real time of a large number of subjects, e.g. persons being screened in an airport.

This application claims the benefit of U.S. Provisional Application No. 60/618,048, filed Oct. 12, 2004.

### BACKGROUND OF THE INVENTION

1. Field of the Invention

This invention relates to the field of scanner apparatus and methods; and more particularly to a walk-through, multi-zonal system for detecting contraband associated with a human subject.

2. Description of the Prior Art

In recent years, the prevalence of criminal activity that entails transportation of weapons and contraband materials has been a significant public concern. It has thus become vital to develop systems for detecting the presence of these materials, both if shipped as luggage or cargo and if carried by an individual. Of particular urgency is the need to detect items used as weapons by terrorists, including ordinary firearms and knives, items such as explosive or incendiary substances, and materials which present biological, chemical or radiological hazards to people and property. The detection of illicit drugs and narcotics being transported is also of concern.

The detection of contraband in the context of air and rail transportation is especially challenging, given the need to examine large numbers of both people and articles of luggage and cargo within acceptable limits on throughput and intrusiveness. Although physical inspection is a widely practiced and important technique, it is slow, cumbersome, labor intensive, and dependent on the alertness and vigilance of the inspector. Physical inspection of people also raises significant concerns of privacy and societal acceptability.

As used herein, the term “contraband” is intended to denote substances or articles whose transportation or possession is forbidden or improper. A wide variety of substances or articles may be considered as contraband, including non-exclusively: firearms and similar weapons; explosives and explosive devices; incendiaries, propellants, and accelerants; drugs such as heroin, cocaine, opium and its derivatives and other narcotics, cannabis (including marijuana and hashish), amphetamines and barbiturates; hallucinogens and psychotropics; and other substances and articles which present biological, chemical or radiological hazards to people and property.

Automated systems that screen for contraband have been sought for many years. Various techniques have been proposed to detect contraband objects and materials either directly or indirectly. Magnetometry is widely used, and relatively effective in detecting metallic objects carried by persons. Nuclear techniques, including x-ray, gamma-ray, neutron activation, and nuclear magnetic resonance methods, are applicable for screening inanimate objects, but pose risks that generally preclude their use for screening humans. In some cases, they are able to detect metallic objects, including weapons and ancillary devices such as wires, power supplies, batteries, and triggering mechanisms for explosive devices. However, there increasingly exist threats posed by largely non-metallic objects, which the aforementioned methods are less able to detect. The advent of modem plastic explosives presents an especially significant threat. Even a modest, readily concealable amount of these substances can cause a substantial explosion. Moreover, miscreants have become increasingly adept at disguising weapons and explosive devices as ordinary, innocuous objects. As a result, more refined, indirect methods for detection of explosives are urgently sought. Ideally, the detection should screen for explosives both directly associated with a person and in luggage or the like. Although there are some commonalities, screening humans is the more difficult challenge. Methods that violate legal rights or are socially unacceptable to the general public are clearly precluded, as are methods that present any substantial risk to health or safety.

Many of the indirect methods rely on the presence of vapor emanating from suspect material transported directly by an individual, or disguised in his/her garments, in luggage, or in other accompanying items. One such indirect method, widely used in law enforcement, employs dogs trained to sniff preferentially for explosives, drugs, and the like. The remarkable olfactory sensitivity of dogs has been known and exploited for centuries. However, they are subject to fatigue, behavior variations, and the need for careful handling, training, and reinforcement from their masters. It therefore remains highly desirable to have scanning systems and methodologies that are not subject to these limitations. Also needed are scanning systems that can rapidly and accurately discriminate among different substances and indicate the quantity and location of a critical substance.

The task of indirectly detecting the presence of suspect materials is further complicated by their wide variability in vapor pressure. Some explosives, including nitroglycerin (NG), dynamite, EGDN, and EGTN, are comparatively volatile, exhibiting significant vapor pressure at room temperature. DNT and TNT have lower, but still appreciable room-temperature vapor pressure. However, some of the most critical materials for which detection is sought, e.g. drugs, such as cocaine and heroin, and plastic explosives, such as SEMTEX and C-4, are far less volatile, having room temperature vapor pressures as much as ten million times lower. It is virtually impossible to detect vapor naturally emanating from these low volatility materials. They are even more difficult to detect if sealed inside luggage or packaging.

It is known that certain contraband materials for which detection is sought are inherently sticky. This characteristic is a notable property of many plastic explosives. As a result, particulate residues are likely to be present: (i) on the hands or garments of a person who has even casually handled the contraband, even after repeated washing; (ii) in fingerprints on surfaces or items such a person has subsequently touched, and (iii) as cross-contamination on the surface of a vehicle, shipping container, or luggage in which the material has been placed. For example, a measurable amount of ammonium nitrate (AN) residue has been found on the lease documents for rental trucks; and significant amounts of the explosives PETN (pentaerythritol tetranitrate) and/or AN have also been found on clothing and inside vehicles of suspects in two well-publicized bombings. Therefore, explosive residue will likely persist in large amounts on the explosive packaging and its environs, as well as on parts of the body or clothes of the individuals involved in building, handling, and transporting the explosive device, thereby providing an avenue for detection of the presence of explosives. The detection of even trace residues of critical substances relatable to a person suggests a strong likelihood of association with illicit activity warranting further investigation.

The dual challenges of sample collection and analysis continue to impede development of satisfactory screening systems for the aforesaid contraband materials, whether on people or on inanimate objects such as cargo and luggage. As previously described, many of the materials whose detection is most critical have extremely low vapor pressure. The equilibrium concentration in the atmosphere near a contaminated fingerprint may be only parts per billion or trillion, a value too low for known detection schemes that sample only ambient vapor. Hence, previous detection methods have ordinarily necessitated some means for augmenting the available sample. For example, in some systems disposable swabs or wipes of dry paper or cloth are rubbed by an operator against luggage or shipping containers to pick up detectable amounts, if any, of particulate residue. Such wipes may also be wetted with a solvent to facilitate residue pickup. In either case, the wipe is subsequently transferred to a suitable detection system for chemical analysis.

However, known wipe systems have a number of significant limitations. They generally require an operator and are not conveniently adapted to automation. Their throughput is limited by the cumulative time needed for the essential multiple operations. In addition to the actual analytical time, the process requires the prior intermediate steps of wiping the article under test and transferring the wipe to the detection system. The detection efficacy and success of wipe systems is generally dependent on human factors. Stress and the frequent confusion extant in a busy public facility may cause an operator to fail to carry out an adequate sampling. For example, the wiping operation frequently fails to covet a sufficiently representative portion of an article to insure that whatever residues are present are actually captured.

Other known systems have employed mechanical brushing or shaking of articles or impingement of a gas stream (ordinarily air), either continuously or in pulses or bursts, to dislodge residue particles. Such systems have been proposed for detecting the presence of suspect material on a human subject passing through a tunnel-like portal. While these methods are more amenable to automation than wiping-based methods, they heretofore have not been sufficiently fast and efficacious for the demanding requirements of rapidly screening large numbers of human subjects, such as airplane passengers.

Flowing gas is at best a relatively inefficient vehicle for collecting adequate sample. Disruptions of the airflow owing to the motion of subjects passing through the portal further compromise sample collection. Any contraband present is relatively dilute in the large volumes of gas that typically must be collected. The resulting need to pre-concentrate the sample limits the analysis rate, making it difficult to reliably associate detection of contraband substances of interest with a specific person passing through the sampling portal. The large volume of air that must be collected dictates a requirement for supplying air replacement, through either large blowers or compressors. Such equipment is bulky and noisy. Screening often must be done in locations, e.g. near airport departure gates, that lack adequate space for installing such equipment, so air must be ducted or piped from a remote location at great expense and difficulty. Both the system operators and the general public find the equipment noise, the intrusiveness of the air, and the psychology of being confined in a long passage highly undesirable.

Several approaches for screening people have been proposed that involve collection of airborne samples. U.S. Pat. No. 6,073,499 to Settles discloses a portal that relies upon the continuous process by which microscopic flakes of skin continuously separate from human subjects, and further upon the existence of a human thermal plume consisting of a layer of warm air adjacent the subject. The rise of warm air in the cooler surrounding air is said to transport the microscopic flakes upwardly. An optional low speed flow of relatively dense cool air is optionally introduced into the portal to buoyantly lift the warmer air of the human thermal plume upwardly. A funnel-shaped collector above the portal is used to collect the particles into a trap that cooperates with a detector. The thermal plume arises from the low-level heat continually radiated by the body. The associated flow rate is modest, and said to be of the order of 30-50 l/s, with a vertically directed speed of as much as 0.5 m/s.

Very different approaches are suggested by other references, involving the impingement of substantial volumes of air onto the subject being examined. In some cases, the subject is located in a fixed, closed chamber such as a closed booth, a corridor with doors at both its ends, or a revolving door. Other arrangements include a passage delimited at its ends by curtains formed of parallel, ribbon-like strips of plastic or the like. U.S. Pat. No. 4,045,997 to Showalter et al. provides an air curtain device comprising two spaced-apart cabinets defining a walkway through which a subject passes. An air curtain is set up between the cabinets. One vertical wall of the first cabinet is provided with an air discharge grill while a vertical wall of the second cabinet directly opposed to the first contains a corresponding and complementary air intake grill. An air velocity profile established by a synchronized flow from the first cabinet to the second. Uniformity of the profile is said to be important. Air received through the intake grill is submitted to an analyzer for detecting substances of interest.

U.S. Pat. No. 5,915,268 to Linker et al. discloses a portal apparatus including a test space in which a subject stands. The portal is equipped with an overhead fan that produces a downwardly directed flow of air collected by a vent intake near the portal floor. The air is then sent to a detector for a requisite analysis.

U.S. Pat. No. 4,987,767 to Corrigan et al. provides an explosive detection system wherein a subject passes through a passageway of extended length. The length is said to overcome the problem of the dilution of the substances of interest in air. The chamber is long enough to provide a transit time sufficient to allow a meaningful sample of the subject's environment to be gathered.

Another approach is taken in U.S. Pat. No. 4,964,309 to Jenkins, which discloses a portal having a plurality of swinging panels hinged on the side frames of the portal. To pass through, a subject deflects the panels, which include sampling tubes with intake ports. Vapor samples are drawn in and passed into a vapor analyzer. The bodily movement involved in pushing the door open is said to act to pump vapors out of voids in the subject's clothing, making the vapors available for analysis.

Notwithstanding the aforementioned schemes for sample collection and analysis, there remains a need in the art for integrated systems capable of reliably, accurately, and rapidly detecting the presence of contraband substances—especially explosives, accelerants, and illicit drugs. More particularly, there exists an urgent need for systems that are readily automated for semi-continuous or continuous inspection and screening of human subjects to detect such materials, whether carried directly or in a garment, luggage item, or the like, or as a residue from handling contraband. Such systems are highly sought, especially in the context of airport screening, but would be equally valuable for courthouses, stadiums, schools, government offices, military installations, correctional institutions, and other public venues that might present targets for terrorist or similar criminal activity.

### SUMMARY OF THE INVENTION

The present invention provides a walk-through, multi-zonal method and system for detecting small quantities of explosives and other contraband substances present on the skin or clothing of a human subject, or otherwise closely associated with the subject. Generally stated, the system provides an examination station, which is located in a passageway, portal, tunnel or similar defined space or enclosure. The subject passes through the examination station, wherein the detection process is effected. The system further includes sample generation means to produce a sample for analysis; collection means operative to acquire and convey the sample thus generated; analysis means in communication with the collection means to receive the sample and carry out a chemical analysis to detect one or more substances of interest in the sample; and signal means operably connected to the analysis means for indicating detection of the one or more substances of interest.

It will be understood that the sample collected and analyzed in accordance with the present system and method may comprise a gaseous vapor, an aerosol, or small solid particles of a substance of interest, or mixtures thereof. The sample may also comprise particles of a generally inert material (e.g. textile lint, flakes of skin or hair, or the like) bearing some amount of the substance of interest.

In one aspect, there is provided a walk-through, multi-zonal system for detecting contraband substances associated with a human subject. Objects containing such substances may be carried by the subject or in a garment worn by the subject, or as vapors entrained by the subject's garments. Alternatively, the substance may be present as small particles or residues present on skin, garment fibers, or the like that may be dislodged from the subject or his immediate effects. The system comprises: (i) an examination station through which the subject passes; (ii) sample generation means to produce a sample for analysis, comprising a plurality of air jets disposed in the examination station to impinge flowing gas onto pre-selected zones on the subject; (iii) collection means operative to acquire and convey the sample, comprising a plurality of collection ports disposed in the examination station to receive gas deflected by the subject from the air jets; (iv) analysis means in communication with the collection means to receive the sample and carry out a chemical analysis to detect the contraband substances; and (v) signal means operably connected to the analysis means for indicating detection of the contraband substances.

There is further provided a method for detecting contraband substances associated with a human subject. A walk-through passageway through which the subject passes is provided and includes: (i) an examination station associated with said passageway; (ii) a plurality of air jets disposed in the examination station to impinge flowing gas onto pre-selected zones on the subject; (iii) a plurality of collection ports disposed in the examination station to receive gas deflected by the subject from the air jets; (iv) at least one detector in communication with the collection ports; (v) a signal device operably connected to the detector for indicating detection of the contraband substance. The method further comprises: generating a sample for analysis from gas impinging on the subject from the air jets; collecting the sample using the collection ports; communicating the sample to the detector; detecting the contraband substance in the sample using the detector; and activating the signal device upon detection of the contraband substance by the detector.

The detection is preferably carried out using a chemiluminescence detection method wherein luminol reacts with NO₂ to produce optically detectable light. Use of this reaction enables a compact scanning system in accordance with the present invention to detect the presence of a wide variety of contraband substances in an accurate and reliable manner. The system rapidly and accurately discriminates among different substances and in some implementations provides quantitative indication of the amount and location of a critical substance. It is especially well suited for use in applications which require high throughput and accuracy, such as security screening associated with airline and other forms of public transportation. The system can detect the presence of a wide variety of contraband substances. In general, any of these materials which may be decomposed to produce NO₂ may be readily detected.

In a further preferred implementation, analysis is carried out using luminol-based chemiluminescent detection for initial screening. If the presence of a substance of interest is suspected based on the chemiluminescence analysis, additional inspection can be carried out, preferably employing additional analytical that in some instances are slower in throughput but more accurate and preferably able to detect and identify particular substances. GC/IMS is one preferred technique having this capability.

Advantageously, the system provides in some aspects for automated screening. It can be configured to automatically scan substantially the entire exterior surface of luggage and other hand-carried personal items, as well as cargo, without the need for hand wiping or sampling by an operator or other physical contact. Vagaries of human performance are virtually eliminated, and detection efficacy is improved. The system's greater speed, accuracy, reliability, and flexibility, as well as its lower cost, and expanded range of detectable substances overcome problems associated with commercial scanning systems. Importantly, the system of this invention markedly reduces or eliminates false alarms while maximizing detection sensitivity for actual contraband.

The present system is useful in a variety of situations that require rapid and accurate but thorough screening of large numbers of people, especially including security screening associated with airline and other forms of public transportation. Real-time, automated detection is accomplished in an accurate, reliable manner. As a result, the inevitable vagaries of human performance are virtually eliminated, improving the efficacy of detection. The present system is also useful for screening in other contexts, including courthouses, stadiums, schools, government offices, military installations, correctional institutions, and similar public venues that might be targets of terrorist or similar criminal activity. The combination of speed, accuracy, reliability, flexibility, low cost, and range of critical substances detectable solves problems associated with prior art scanning systems and renders the present invention highly beneficial. Furthermore, the present invention markedly reduces or eliminates false alarms while maximizing the probability of detection of actual contraband.

### BRIEF DESCRIPTION OF THE DRAWINGS

The invention will be more fully understood and further advantages will become apparent when reference is had to the following detailed description of the preferred embodiments of the invention and the accompanying drawings, wherein like reference numeral denote similar elements throughout the several views, and in which:

FIG. 1 is a plan view depicting a walk-through system of the invention for screening humans for explosives or other contraband materials, including individual kiosks in which the detectors are situated;

FIG. 2A is a plan view depicting in more detail the arrangement of components in one of the kiosks also shown in FIG. 1;

FIG. 2B is a side elevation view of the kiosk, corresponding to the plan view of FIG. 2A;

FIG. 3 is a side perspective view schematically depicting the kiosk also seen in FIGS. 2A-B and showing the multi-zonal arrangement of components therein; and

FIG. 4 is a schematic diagram depicting the association of various components of the present system.

### DESCRIPTION OF THE PREFERRED EMBODIMENTS

Preferred embodiments of the present invention will be explained in greater detail hereinafter, with reference to the accompanying drawings.

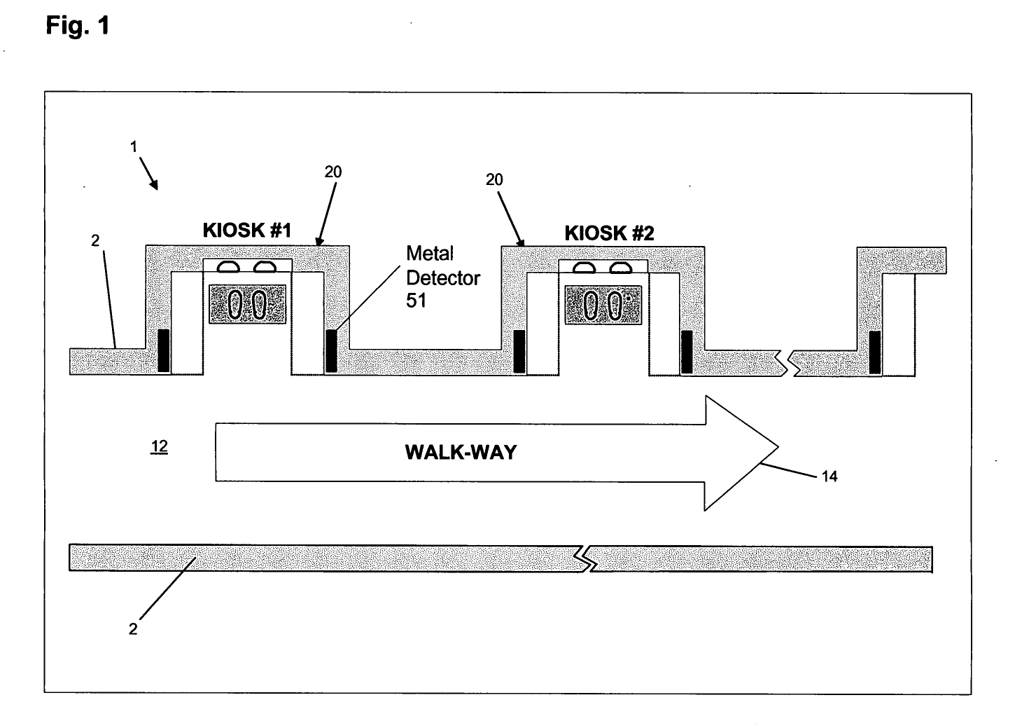

Referring to FIG. 1, there is shown one implementation of a multi-zonal system 1 for detecting small quantities of explosives and/or other contraband substances present on the skin or clothing of a human subject, or otherwise closely associated with the subject. System 1 is preferably configured to be deployed in an airport or similar public facility at which screening for contraband is a pressing societal need. System 1 comprises a tunnel-like portal open at opposite ends connected by passageway 12, which is further defined by flanking passageway side walls 2. Subjects walk through the passageway 12 in the direction generally indicated by arrow 14. The portal is dimensioned to accommodate persons of various sizes. For example, the vertical height may be about seven feet and the width transverse to the passage direction may be about three feet, permitting the passage of persons either walking normally or using a wheelchair or other like assistance device. At least part of sidewalls 2 is preferably made of glass, transparent plastic, or the like, to alleviate possible feelings of claustrophobia for persons passing through passageway 12.

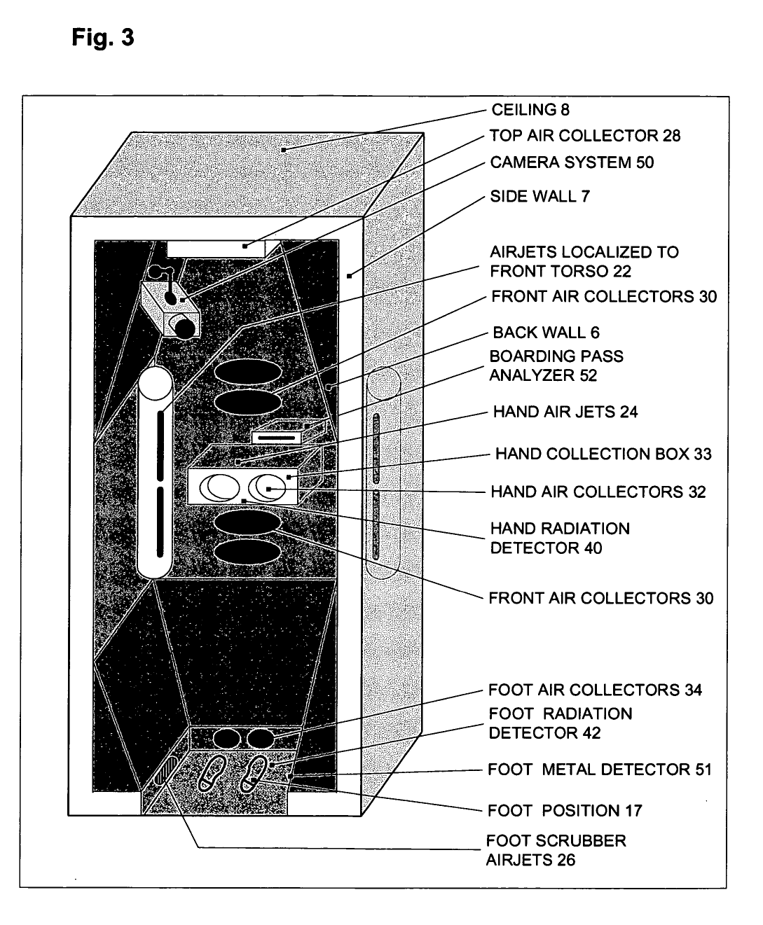

One or both of the passageway sidewalls further includes booth-like, U-shaped kiosks 20 opening into passageway 12. As best seen in FIG. 3, kiosk 20 has a back wall 6 opposite its open side and kiosk side walls 7 joining back wall 6 to the passageway side wall 2 into which kiosk 20 opens. FIG. 1 depicts two substantially identical kiosks, but it will be understood that there may be only a single kiosk or any other number of kiosks. A subject is directed to appear in any of the kiosks 20 for the screening process. Although less preferred, in other embodiments, different kiosks are appointed for carrying out different aspects of the overall screening, and the subject is directed to appear sequentially in more than one kiosk so that a full screening process may be accomplished. Although the implementation shown comprises a passageway defined by side walls 2, in other forms one or both of the side walls may be omitted. Kiosk 20 may also be a free-standing structure.

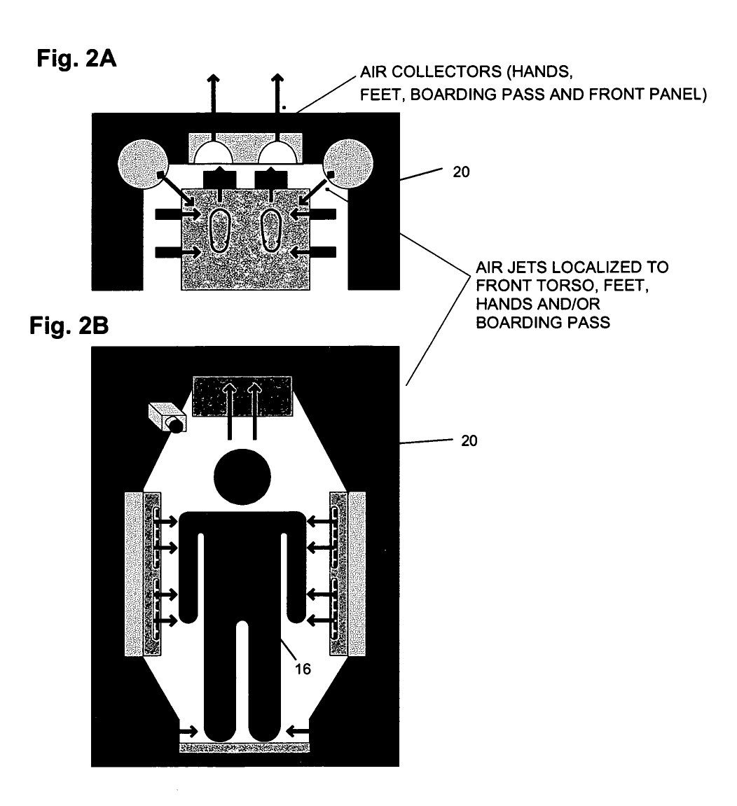

The configuration of kiosk 20 is further illustrated in FIGS. 2-4, which depict plural air jets 13 and collection ports 15 used in carrying out the present screening process. Air (or other compressed gas) emitted from the air jets impinges onto subject 16, typically dislodging skin particles, residue (if any) on the skin or garments, and garment fibers. The removal of vapors, particles, fibers, and the like, is optionally describable as a “scrubbing” action. If subject 16 is carrying, or has recently handled, a contraband substance, the dislodged material is almost certain to contain such material. The jets and collection ports are disposed in zones corresponding to preselected portions of the body of subject 16. The flowing air may also serve to impel the various residues and substances into the collection ports. In the implementation depicted, the zones generally correspond to the head, torso, hands, and feet of subject 16. Of course, jets and collection ports may also be positioned to interrogate other regions deemed to be important. The system optionally includes valving means for activating only some of the jets or collection ports. For example, the system might include a height sensor so that different jets could be selectively activated to better localize the air flow to accommodate subjects of different stature.

FIG. 3 depicts additional details of the configuration of kiosk 20, which includes a back wall 6, two kiosk sidewalls 7, and a ceiling 8. The size and configuration of kiosk 20 are selected to accommodate individuals of a wide range of height and weight standing at foot positions 17 and facing back wall 6. Kiosk 20 includes air jets 13 and collection ports 15 situated in accordance with proportions of an average human standing in the appointed position. In particular, one or more air jets are located to intercept the subject in zones corresponding to the front torso 22, the hands 24, and the feet 26. Collector ports are correspondingly located above the head at 28, at torso level 30, and at the feet 34. Collection ports 32 for the hands are preferably located within a collection box 33. As an alternative, hand air jets 24 and hand collection ports 32 may be replaced by, or supplemented with, a touch surface that is analyzed by a detection system for residue transferred via fingerprints. Preferably, the touch surface comprises a paper wipe that is indexed to provide a fresh surface uniquely associated with each successive subject. Material collected on the touch surface may be transferred to the same analysis system that receives air from the other collection ports, or alternatively to a different analysis system. The subject is positioned in kiosk 20 in a normal, standing position facing back wall 6 for a time sufficient to allow collection of representative samples from each of the aforementioned zones. Preferably there is provided an audible or visible indicator directing subjects to enter and exit the kiosk one at a time, such as a “red light-green light” system like that used as traffic signals or a speaker providing verbal commands.

The configuration of air jets 13 and collection ports 15 in certain implementations of the present system provides a number of features not present in prior art systems, either those that rely on natural convection currents extant near a human or those that employ a high-volume gas flow. The air jets in the present system are located for maximum benefit. In particular, air jets in the present system impinge on portions of the body that are most likely to bear explosive residues, while minimizing the amount of air directed at less relevant areas. As a result, any residues actually dislodged are not adversely diluted by air that is unlikely to sweep up any substances of interest. Moreover, the selectively directed nature of the present air jets may mitigate objections that more general, high velocity air jets used in other systems are perceived as intrusive and uncomfortable for some individuals. In some implementations, the reduced airflow and use of a highly sensitive detector allows omission of a pre-concentrator ahead of the detector. The system is thus simplified more reliable. Analysis time is reduced, improving throughput and improving the specificity of detection, both as to the identification of the specific subject on whom substances are detected and as to the specific body zone at which the substances were detected.

The reduced airflow needed in the present system further allows the entire screening apparatus to be made smaller, since the compressors, pumps, or blowers needed may be smaller. Size is often a significant concern for screening systems that must be retrofitted in limited available space in existing airports or other public facilities. Noise emanating from air-handling equipment, often objectionable in prior art systems, is reduced. Electric power requirements are also reduced.

Additional features optionally present in the kiosk include radiation detectors 40, 42 (e.g. sensitive to one or more of alpha, beta, and gamma radiation and neutrons) respectively for the hands and feet, one or more metal detectors 51, and a video camera system 50. Preferably camera system 50 is connected to detector 64, so that detection of contraband substances may be associated with one or more images of a particular suspect.

It is also preferred that the system include an analyzer 52 for scrutinizing boarding passes or other documents. For example, analyzer 52 may comprise a port into which the person inserts his boarding pass, identification card, or similar document. As previously noted, handling of some forms of explosives and other contraband substances, especially plastic explosives, transfers some sticky residue having traces of the explosive substance onto the person's hands. This residue, in turn, is likely to be further transferred to other objects he/she handles. Document sampling provides a still further level of security, based on the identification of persons who have handled contraband within a time prior to encountering the present scrutiny. In some implementations, analyzer 52 might also include means for reading a bar code, magnetically encoded strip, or other indicia on the document inserted, whereby the identity of the subject is ascertained. Analyzer 52 may include means for lifting a sample from the document, such as another air jet, a mechanical wiping or brushing operation, or a laser, along with collection means. For example, analyzer 52 may include another air intake port communicating with the other collection ports 15. Alternatively, a separate detection system dedicated analyzer 52 may be used.

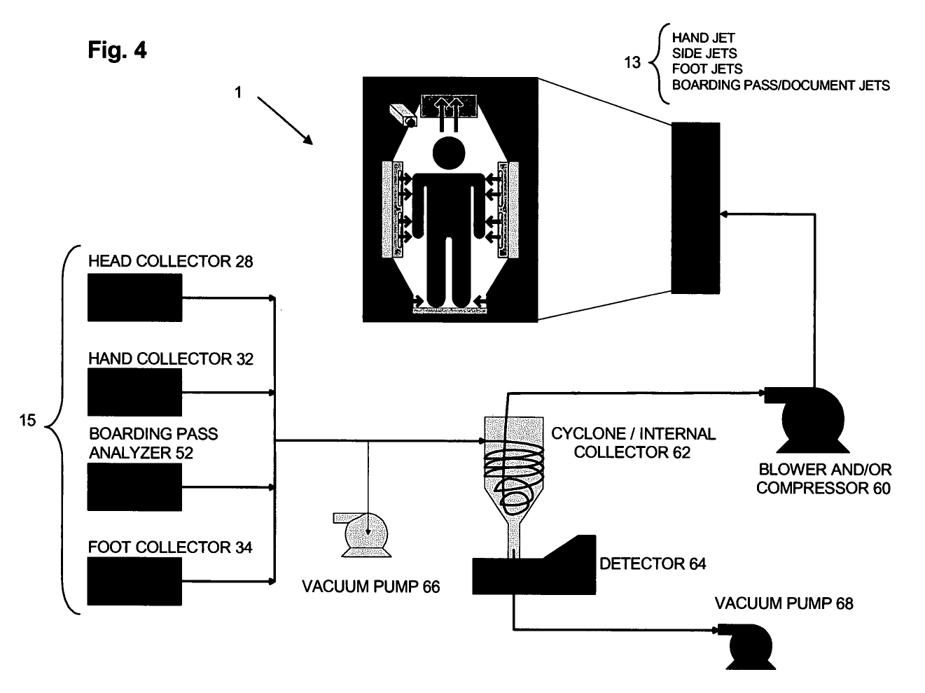

FIG. 4 depicts the association of the air jets 13 and collection ports 15 in kiosk 20 with other equipment. In the implementation shown, air to energize the air jets is provided by blower or compressor 60, which is connected to the jets also shown in FIGS. 1-3 by suitable piping or ducting. Other sources of compressed air or gas, such as a compressed gas bottle, are alternatively used. Air collected in the collection ports 15 is conveyed through piping to a suitable detector 64 for analysis. In the embodiment shown, air samples received by all of the collectors are fed to a common manifold. The air sample is optionally passed through an internal collector 62 that collects and concentrates the sample. Such a collector may accomplish at least one of: condensing volatile substances, removing extraneous foreign matter, and concentrating particulate matter such as skin flakes and textile fibers, at least a portion of which may bear residues if the individual is carrying or has recently handled contraband. For example, in some embodiments a cyclone is employed to concentrate particulate materials. Alternatively, other collector types, such as filters, traps, and impactors are employed. The collector optimally comprises an adsorbent material to collect vapor-phase, aerosol, or fine particulates. Flash heating of the adsorbent is optionally used to rapidly liberate such materials collected over a longer interval, thereby effecting concentration. The collected sample, possibly after concentration by concentrator 62, is then passed to detector 64, which employs one or more analytic techniques capable of detecting and/or identifying and discriminating substances of interest. In other embodiments (not illustrated), the different collection ports are connected to separate detection systems employing different detectors, which are preferably similar in design and operational principle, but need not be. Vacuum pumps 66 and 68 are optionally employed to promote airflow through the piping connecting the collection ports to the internal collector (if present) and thence to the detector 64. The embodiment shown further recirculates air taken in through collection ports 15 and collector 62, and ultimately routes it back through compressor 60 and back through air jets 13, but this recirculation is not required in all embodiments. Instead, the intaken air may be vented separately after analysis. In still other implementations, a valving system is used to multiplex the detection process. That is to say, the various collection ports are activated at different times during the examination of each individual, and the valves are sequenced such that the detector is sequentially given samples obtained from different sites on the subject. A positive detection thus may be associated with a particular zone from whence a sample containing the detected material came. In both the multi-detector and multiplexed implementations, the detection of contraband may be at least somewhat localized on the body of the subject. Most or all the functions of the present system are preferably operated by a computer, such as a general-purpose computer (not shown).

Detector 64 is operably connected to a signal means (not shown). Typically the detector provides an electronic output of either digital or analog form. If a substance of interest is detected, signal means is activated in response, e.g. upon receipt of an electronic output of preselected form.

In an aspect of the invention, the detector provides an electrical output signal representative of the detection of a contraband substance. Preferably the output signal has a magnitude that is proportional to the amount of a substance being detected. The detector may be adjusted and calibrated by an appropriate protocol, such as by establishing a background electrical output when it is known that no substance is actually present or by exposing the detector to a sample with a known concentration. It is then presumed that any signal above a preselected background level is indicative of the presence of a substance of interest. Alternatively, a background level may be determined dynamically during scanner operation by a known averaging protocol.

Indication of the detector signal output may be given by a wide variety of signal means known in the art. Preferably, the signal means is enabled using the aforementioned general-purpose computer and a monitor associated therewith. A binary “go/no go” indication may be provided using known comparator circuitry, in which the magnitude of the signal actually outputted by the detector is compared with a pre-selected detection threshold, and in response, audible or visible signals are activated, indicative of the presence or absence of a signal above the pre-selected threshold. The output of the detector may also be displayed as a quantitative reading on a digital or analog meter or bar display. The signal means may also comprise a computer display screen or terminal, which may display a reading in alphanumeric form or in an image simulating an analog mechanical meter or gage. Implementations having the aforementioned multiple detectors or multiplexing preferably also include a visual output, such as an intensity or false-color pattern displayed on a monitor such as a computer display screen or terminal, that provides an extended, two-dimensional indication of the amount and location of material detected, which is preferably superimposed on an image such as a cartoon image or an actual image of the subject acquired by camera system 50. For example, the presence or amount of different contraband substances may be represented by different colors, intensity, or shading patterns. The signal means may also be capable of transmitting an alarm by wired or wireless transmission to alert police or other authorities to the possible detection of contraband substance

A wide range of detectors may be employed in the present system. Ideally, a detector system is highly sensitive to the substances of interest and is capable of carrying out rapid, reliable, and accurate analysis in real time. One currently preferred detector for use in the present system is provided by commonly assigned U.S. patent application Ser. No. 10/241,407, filed Sep. 12, 2002, which application (hereinafter, “the '407 application”) is incorporated herein in the entirety by reference thereto.

In particular, the '407 application provides an apparatus for detecting the presence of NO₂ in air. The NO₂ combines with luminol in a gas-liquid phase chemical reaction that produces light by chemiluminescence. Detection of the resulting light provides evidence of the presence of NO₂. As described in the '407 application, pyrolysis of a wide range of contraband substances, notably including virtually all common explosives and taggants, including organo-nitro explosives, as well as many other contraband substances of interest, produces NO₂ in amounts considerably higher than ordinarily present in ambient air in accordance with reactions of the following type:

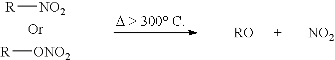

The NO₂ then reacts with luminol as follows:

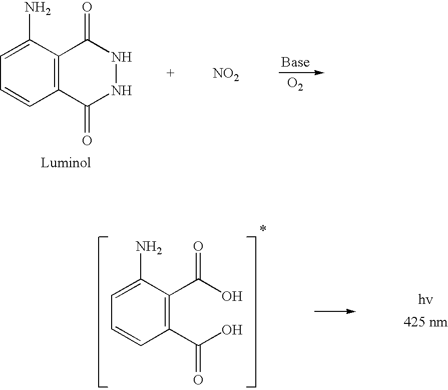

The light thereby produced can readily be detected by a light detector, such as a photomultiplier tube (PMT). Advantageously, conventional PMT's are quite sensitive to light of the wavelength produced, which has a wavelength centered at approximately 425 nm.

In addition, this chemiluminescent reaction can be made quite selective to NO₂ under suitably chosen conditions, so that other nitrogen-containing compounds, including ammonia, organic nitrite, organic nitrate, NO, and hydrocarbons do not interfere.

The luminol-NO₂ reaction method has several significant advantages over previous methods for detecting NO₂. In one known method, NO₂ is first converted to nitric oxide (NO), which is subsequently reacted with ozone (O₃). This reaction is also chemiluminescent, but the light emitted has a substantially different peak wavelength. Such a method requires two reaction steps and provision of a source of O₃, making both the method and the apparatus needed to carry it out more complicated, expensive, and difficult to implement than the present invention. Furthermore, the method is highly prone to inaccuracy, since there is no means for discriminating between (i) the relatively small amount of NO derived from the NO₂ from pyrolyzed explosive and (ii) ambient NO, which is a common air pollutant often present in substantially larger concentration.

Implementations of the present system preferably employ a preconcentrator or collector that receives gas taken in through the collection ports, along with small particulate matter, aerosols, and the like carried by the gas flow. The collector then concentrates the material and transfers it to the one or more detectors, increasing the concentration of substances of interest in the gas. In some embodiments, the collector is a simple wire or mesh screen that aggregates and/or adsorbs material. The screen is then heated to vaporize the material collected. Preferably the screen is a metallic mesh that can be heated by passage of an electrical current therethrough.

In other forms, the preconcentrator employs an adsorbent medium including non-exclusively molecular sieves, activated charcoal, glass wool, or the like. Gas chromatograph column materials are preferred, such as a powder of poly(2,6-Diphenyl phenylene oxide) available commercially from the Enka Research Institute Arnhem under the tradename Tenax GC™. Such materials are also allowed to collect material, then exposed to a heat source, e.g. an infrared or electrical resistance heater to vaporize the material in a more concentrated form amenable to analysis.

Used in conjunction with a suitable pyrolysis cell, the '407 chemiluminescence analysis apparatus can be employed along with suitable sample generation and collection means in the present screening system and method. Especially preferred is a system of a type disclosed by the '407 application, wherein luminol is provided in a reaction cell comprising an alkaline, aqueous, luminol-containing solution separated from a reaction zone in the reaction cell by a semi-permeable, hydrophobic membrane. Such a system provides a stable, easy to establish calibration, leading to high reliability under the demanding conditions imposed by high throughput screening in public places like airport concourses. Chemiluminescence technology makes possible near real time analysis, and is also highly sensitive and reliable in detecting certain classes of explosives, such as taggants (volatile explosives impregnated into plastic explosives to make them detectable as vapors), TATP, ammonium nitrate, black powder. Other analysis methods have significantly greater difficulty in responding to such materials.

However, the present system may also employ any other suitable detection system and method. For example, any of the following detector modalities are believed to be suitable: gas chromatograph/surface surface ionization (GC/SID), gas chromatography/mass spectrometry (GCIMS), gas chromatograph/ion mobility spectrometry (GC/IMS), field ion spectrometry (FIS), photoacoustic spectroscopy, and gas-phase infrared spectroscopy detection methods.

The present system is also capable of detecting NO₂ produced by the decomposition of inorganic nitrate salts used as explosives, such as ammonium nitrate (AN) or mixtures of ammonium nitrate with fuel oil or the like (ANFO). In addition, the luminol reaction system of the present invention can be used to detect organic peroxides. Exemplary of such detection is the following reaction with a commonly used explosive material, tri-acetone tri-peroxide (TATP):

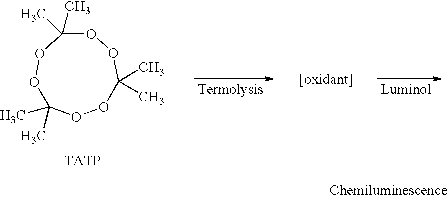

In another aspect, the present system advantageously employs the fast, robust, and reliable screening afforded by luminol-based chemiluminescent detection to identify persons who may be carrying contraband material or who have recently handled such material. Those identified persons can then be scrutinized more intensively, e.g. by physical searching, to confirm the apparent detection. Such off-line searching improves the overall effectiveness of the present screening system, since more time-consuming, intrusive searching need be done for only a few subjects. Moreover, the operating conditions for the follow-up scrutiny can be optimized to enhance sensitivity and system durability, since the follow-up analysis is not the throughput rate-limiting factor in the present screening system.

Having thus described the invention with rather full detail, it will be understood that such detail need not be strictly adhered to, but that various changes and modifications may suggest themselves to one skilled in the art. For example, the present invention has been described in relation to the screening of human beings, but similar apparatus and methods could also be used to screen animals or inanimate objects such as cargo, luggage, or the like. Conveyor belts or other mechanical means may be used to convey persons or objects through the examination station. Other detectors or gasses may be used, as may additional detection modalities. It is accordingly intended that such modifications be encompassed by the scope of the invention, as defined by the subjoined claims.

What is claimed is:

1. A walk-through, multi-zonal system for detecting contraband substances associated with a human subject, the system comprising:
a. an examination station through which said subject passes;
b. sample generation means to produce a sample for analysis, comprising a plurality of air jets disposed in said examination station to impinge flowing gas onto pre-selected zones on said subject;
c. collection means operative to acquire and convey said sample, comprising a plurality of collection ports disposed in said examination station to receive gas deflected by said subject from said air jets;
d. analysis means in communication with said collection means to receive said sample and carry out a chemical analysis to detect said contraband substances;
e. signal means operably connected to said analysis means for indicating detection of said contraband substances.

2. A system as recited by claim 1, wherein said analysis means comprises at least one detector selected from the group consisting of chemiluminescence, gas chromatograph/ion mobility spectrometry, gas chromatograph/surface surface ionization, gas chromatography/mass spectrometry, field ion spectrometry, photoacoustic spectrometry, and gas-phase infrared spectrometry detectors.

3. A walk-through, multi-zonal system for detecting contraband substances associated with a human subject, the system comprising:
a. a passageway through which said subject passes, comprising passageway sidewalls and a walkway therebetween;
b. at least one U-shaped, walk-in kiosk having an open side opening from one of said sidewalls, a back wall opposite said open side, kiosk side walls connecting said back wall and said passageway side walls, and a ceiling;
c. a plurality of air jets in fluid communication with a source of compressed air and adapted to impinge said gas onto preselected portions of said subject, said preselected portions comprising at least one of the head, torso, hands, and feet of said subject;
d. a plurality of collection ports disposed to receive gas deflected from said air jets by said preselected portions;
e. at least one chemiluminescence detector in fluid communication with said collection ports, said detector being adapted to detect said contraband substance;
f. Signal means operably connected to said detector for indicating detection of said contraband substance.

4. A system as recited by claim 3, wherein said source of compressed gas comprises at least one of a compressor, a blower, and a bottle of compressed gas.

5. A system as recited by claim 3, further comprising a pre-concentrator disposed between said collection ports and said detector.

6. A system as recited by claim 3, further comprising a boarding pass analyzer.

7. A system as recited by claim 3, further comprising a touch surface adapted to be touched by a hand of said subject, and a detector responsive to residue of contraband transferred to said touch surface by said touch.

8. A system as recited by claim 3, further comprising a video camera system.

9. A system as recited by claim 3, further comprising at least one radiation detector.

10. A system as recited by claim 3, further comprising at least one metal detector.

11. A system as recited by claim 3, further comprising a general purpose computer operable to control at least one of said sample generation means, said collection means, said analysis means, and said signal means.

12. A method for detecting contraband substances associated with a human subject, comprising:
a. providing a walk-through passageway through which said subject passes, said station comprising: (i) an examination station associated with said passageway; (ii) a plurality of air jets disposed in said examination station to impinge flowing gas onto pre-selected zones on said subject; (iii) a plurality of collection ports disposed in said examination station to receive gas deflected by said subject from said air jets; (iv) at least one detector in communication with said collection ports; (v) a signal device operably connected to said detector for indicating detection of said contraband substance;
b. generating a sample for analysis from gas impinging on said subject from said air jets;
c. collecting said sample using said collection ports;
d. communicating said sample to said detector;
e. detecting said contraband substance in said sample using said detector; and
f. activating said signal device upon detection of said contraband substance by said detector.

13. A method as recited by claim 12, wherein said examination station is located within a walk-in kiosk opening into said passageway.

14. A method as recited by claim 12, wherein said detector is a chemiluminescence detector.
